(19) United States
(12) Patent Application Publication
(10) Pub. No.: US 2004/0186892 A1
(43) Pub. Date: Sep. 23, 2004

(54) Network scanner device for transmitting image data through networks and image data transmitting method thereof

(75) Inventors: Tomoko Maruyama, Tokyo (JP); Koichi Nagata, Tokyo (JP); Kana Yamauchi, Tokyo (JP); Toru Maegawa, Hino-shi (JP)

Correspondence Address: Barry E. Bretschneider, Morrison & Foerster LLP, Suite 300, 1650 Tysons Boulevard, McLean, VA, 22102, US

(73) Assignee: Konica Minolta Business Technologies, Inc., Tokyo (JP)

(21) Appl. No.: 10/765,043

(22) Filed: Jan. 28, 2004

(30) Foreign Application Priority Data
Jan. 28, 2003 (JP) 2003-018773

(51) Int. Cl. G06F 15/16; G03B 27/02

(52) U.S. Cl. 709/206; 355/132

(57) ABSTRACT

A network scanner device for transmitting image data through networks, includes a reading section for scanning a document to obtain image data, a first setting section for setting up a recipient address to which the image data is to be transmitted, and a second setting section for setting up a sender address representing a sender in place of a sending station address specifying the device. It also includes a transmission control section for carrying out control for adding to the image data the sender address set by the second setting section and transmitting the image data to the recipient address set by the first setting section. Thereby, a person having performed an operation of image data transmission is capable of easily using reply mail and error mail responding to the transmission.

This application is based on an application No.2003-018773 filed in Japan, the contents of which are hereby incorporated by reference.

### BACKGROUND OF THE INVENTION

The present invention relates to a network scanner device and more particularly to a network scanner device for scanning and reading documents and for transmitting obtained image data through networks.

Herein, the term “network scanner device” refers to a concept that embraces MFP (Multi-Function Peripheral) having other functions such as printer function and facsimile function.

The invention also relates to an image data transmitting method for transmitting image data by such a network scanner device through networks.

Such a type of network scanner device has an address for identifying the network scanner device itself on networks (which address will be referred to as “sending station address”). When image data obtained from a reading unit and attached to electronic mail (email) is transmitted through networks (this operation will be referred to as “image data transmission,” as needed), the sending station address is added to the email.

A recipient who has received the email by his or her terminal (such as a personal computer) connected to a network is allowed to identify a sending station of the email (the image data) on basis of the added sending station address. When the recipient starts a mail software (an application program) on the terminal of the recipient and invokes a reply function, the sending station address is used as an address of reply mail responding to the email. If a failure occurs in transmission paths from the network scanner device to a server on the recipient side, the sending station address is used as an address of error mail from the server on the recipient side.

Mostly, network scanner devices are provided in firms, offices, and the like and are used (operated) by a plurality of persons in turns. After a person (a sender) performs an operation of image data transmission with use of a network scanner device and finishes the operation, the person leaves a place where the network scanner device has been installed and returns to a desk of the person.

This causes a problem in that it is difficult for the sender to make use of reply mail, error mail or the like which might be returned to a sending station address of the network scanner device as described above. Accordingly, in fact, the sender notifies a recipient of a mail address to which the sender desires the recipient to send a reply (a mail address the sender can easily use) through a route different from that of the image data transmission, and thereby the sender may receive the reply mail at the mail address.

A network facsimile device has been known, for example, in which a plurality of mail addresses indicating the device can be registered in a storage unit (see Japanese Patent Application Laid Open No.2002-135505, for example). The network facsimile device still causes the problem described above, to whichever of the plurality of mail addresses reply mail may be sent.

### SUMMARY OF THE INVENTION

Therefore, an object of the present invention is to provide a network scanner device by which a person having performed an operation of image data transmission is capable of easily using reply mail and error mail responding to the transmission, and to provide an image data transmitting method for the device.

In order to achieve the object, the present invention provides a network scanner device for transmitting image data through networks, comprising:

a reading section for scanning a document to obtain image data,

a first setting section for setting up a recipient address to which the image data is to be transmitted,

a second setting section for setting up a sender address representing a sender in place of a sending station address specifying the device, and

a transmission control section for carrying out control for adding to the image data the sender address set by the second setting section and transmitting the image data to the recipient address set by the first setting section.

In the network scanner device of the invention, the reading section scans a document to obtain image data. The first setting section sets up the recipient address to which the image data is to be transmitted. The second setting section sets up the sender address representing the sender in place of the sending station address specifying the device. The transmission control section carries out control for adding to the image data the sender address set by the second setting section and transmitting the image data to the recipient address set by the first setting section. As a result, the image data is attached to email and is transmitted through the networks.

The sender may specify a mail address to which the sender desires replies to be sent (a mail address the sender can easily use), as the sender address set by the second setting section. With this specification, a recipient who has received the email by a terminal (such as personal computer) of the recipient connected to the networks is capable of identifying the sender of the email (the image data) on basis of the added sender address. When the recipient starts a mail software (an application program) on the terminal of the recipient and invokes a reply function, the sender address is used as an address of reply mail responding to the email. On condition that there is some failure in transmission paths from the network scanner device to a server on the recipient side, the sender address is used as an address of error mail from the server on the recipient side. The sender address is an address to which a person (the sender) having carried out operations of image data transmission has desired replies to be sent. Therefore, when reply mail, error mail or the like is delivered to the sender address, the sender is thus capable of easily using the reply mail, the error mail or the like.

The recipient address, the sender address or the like may be registered in (a storage section of) the device in advance before the operations of image data transmission or may be inputted by the sender in the operations of image data transmission.

The order of processes may arbitrarily be altered among the process by the reading section of scanning a document and obtaining image data, the process by the first setting section of setting the recipient address to which image data is to be transmitted, and the process by the second setting section of setting the sender address representing the sender in place of the sending station address specifying the device.

In an embodiment, the network scanner device of the invention further comprises a one-touch setting section for setting up the recipient address and the sender address simultaneously.

In the embodiment, the one-touch setting section simultaneously sets up the recipient address and the sender address. This permits rapid setting of the recipient address and the sender address and improves convenience for users (including senders).

It is desirable for the one-touch setting section to carry out setting described above, in accordance with instructions by a sender. This allows the sender to rapidly specify a recipient address, a sender address, and the like the sender desires.

It is desirable for the network scanner device to have a display section that is capable of displaying a recipient address and a sender address simultaneously on a screen. Thus a sender is capable of viewing the recipient address and the sender address displayed simultaneously on the screen of the display section and checking easily whether the recipient address and the sender address are the same as the sender desires. This further improves convenience for users.

In an embodiment, the network scanner device further comprises a storage section in which candidates of recipient addresses associated with each sender address are stored, wherein, on setting of the sender address, the recipient address is chosen from candidates of recipient addresses associated with the sender address.

In the embodiment of the network scanner device, candidates of recipient addresses associated with each sender address are stored in the storage section in advance before the operations of image data transmission. This arrangement allows listed display of candidates of recipient addresses associated with each sender address. Thus an operator (a sender) does not have to input a recipient address letter by letter but only has to choose the recipient address from the candidates on the operations of image data transmission. This further improves convenience for users.

In an embodiment, the network scanner device further comprises a storage section in which sender addresses associated with IDs representing users are stored, wherein the sender address is automatically set up in accordance with an inputted ID.

The term “ID” refers to numbers, characters or the like for identification of a user. The term “user” has a broad concept embracing operators, senders, and the like.

In the embodiment of the network scanner device, sender addresses associated with IDs representing users are stored in the storage section in advance before the operations of image data transmission. Upon input of an ID by an operator (a sender), for example, as a condition for start of operations of the device, this arrangement allows an associated sender address to be invoked in accordance with the inputted ID. Accordingly, the operator does not have to input the sender address letter by letter on the operations of image data transmission. This further improves convenience for users.

In an embodiment, the network scanner device further comprises an ID input prompting section for making a display that prompts input of an ID representing a user, as a condition for start of operations of the device.

In an embodiment, the network scanner device further comprises an operation panel by which information including the recipient address and the sender address is inputted or chosen.

In an embodiment of the network scanner device, information including the recipient address and the sender address can be inputted through networks.

In an embodiment of the network scanner device, the sending station address specifying the device is included in contents of a text of mail to which the image data is added.

In the another aspect, the present invention provides a network scanner device for transmitting image data through networks, comprising:

image memory in which image data is stored,

a first setting section for setting up a recipient address to which the image data is to be transmitted,

a second setting section for setting up a sender address representing a sender in place of a sending station address specifying the device, and

a transmission control section for carrying out control for adding to the image data the sender address set by the second setting section and transmitting the image data to the recipient address set by the first setting section.

In the network scanner device of the invention, image data is stored in a image memory. The first setting section sets up the recipient address to which the image data is to be transmitted. The second setting section sets up the sender address representing the sender in place of the sending station address specifying the device. The transmission control section carries out control for adding to the image data the sender address set by the second setting section and transmitting the image data to the recipient address set by the first setting section. As a result, the image data is attached to email and is transmitted through the networks. Thereby, a person having performed an operation of image data transmission is capable of easily using reply mail and error mail responding to the transmission, as well as in the previous aspect.

In the another aspect, the present invention provides an image data transmitting method of a network scanner device which attaches image data to electronic mail and transmits the image data through networks according to the present invention, comprising steps of:

scanning a document and obtaining the image data,

setting a recipient address to which the image data is to be transmitted,

setting a sender address representing a sender, in place of a sending station address specifying the device, and

adding the set sender address to the image data and transmitting the image data to the set recipient address through the networks.

In the image data transmitting method of the invention, the network scanner device attaches image data to email and transmits the image data through the networks as follows. That is, a document is scanned and image data is thereby obtained. The recipient address to which the image data is to be transmitted is set up. The sender address representing the sender is set up in place of the sending station address specifying the device. Then, the sender address set by the second setting section is added to the image data, and the image data is transmitted to the recipient address set by the first setting section. As a result, the image data is attached to email and is transmitted through the networks.

The sender may specify, as the sender address, a mail address to which the sender desires replies to be sent (a mail address the sender can easily use). With this specification, a recipient who has received the email by a terminal (such as personal computer) of the recipient connected to the networks is capable of identifying the sender of the email (the image data) on basis of the added sender address. When the recipient starts a mail software (an application program) on the terminal of the recipient and invokes a reply function, the sender address is used as an address of reply mail responding to the email. On condition that there is some failure in transmission paths from the network scanner device to a server on the recipient side, the sender address is used as an address of error mail from the server on the recipient side. The sender address is an address to which a person (the sender) having carried out operations of image data transmission has desired replies to be sent. Therefore, when reply mail, error mail or the like is delivered to the sender address, the sender is thus capable of easily using the reply mail, the error mail or the like.

The sequence of three steps prior to the step of actually transmitting image data may be altered appropriately. That is, the order of steps may arbitrarily be altered among the step of scanning a document and obtaining image data, the step of setting the recipient address to which the image data is to be transmitted, and the step of setting the sender address representing the sender in place of the sending station address specifying the device.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view showing an external view of a scanner device in accordance with an embodiment of the invention;

FIG. 2 is a block diagram showing a configuration of a control system of the scanner device;

FIG. 3 is a diagram showing a network environment provided with the scanner device;

FIG. 4 is a diagram showing an operation panel of the scanner device;

FIG. 5 is a diagram illustrating a sender registration screen in the scanner device;

FIG. 6 is a diagram illustrating a sender choice screen in the scanner device;

FIG. 7 is a diagram illustrating a transmission setting screen finalized in the scanner device;

FIG. 8 is a diagram illustrating a transmission setting screen in which a sender address is being inputted, in the scanner device;

FIG. 9 is a diagram illustrating a transmission setting screen invoked in accordance with an ID representing a user in the scanner device;

FIG. 10 is a diagram illustrating a screen for prompting input of an ID representing a user in the scanner device;

FIG. 11 is a diagram illustrating an address registration screen in the scanner device;

FIG. 12 is a diagram showing a control flow of a transmission stage in the scanner device;

FIG. 13 is a diagram showing a transmission path for error mail in case that there was some failure in transmission paths from the scanner device to a server on a recipient side; and

FIG. 14 is a diagram illustrating a reception history screen on a terminal of a recipient.

### DETAILED DESCRIPTION OF THE PREFERRED EMBODIMENTS

Hereinbelow, the invention will be described in detail with reference to an embodiment shown in the drawings.

FIG. 1 shows an external view of a network scanner device (which will be referred to simply as “scanner device,” hereinbelow) 1 in accordance with an embodiment of the invention. The scanner device 1 is used to scan a document to optically read image data and to transmit through networks the obtained image data attached to email. On top of a main body 10 is provided an automatic document feeder (ADF) 11 for taking in and feeding documents loaded on a tray, sheet by sheet. On a top front surface of the main body 10 is provided an operation panel 12 by which an operator carries out various input operations with respect to the device.

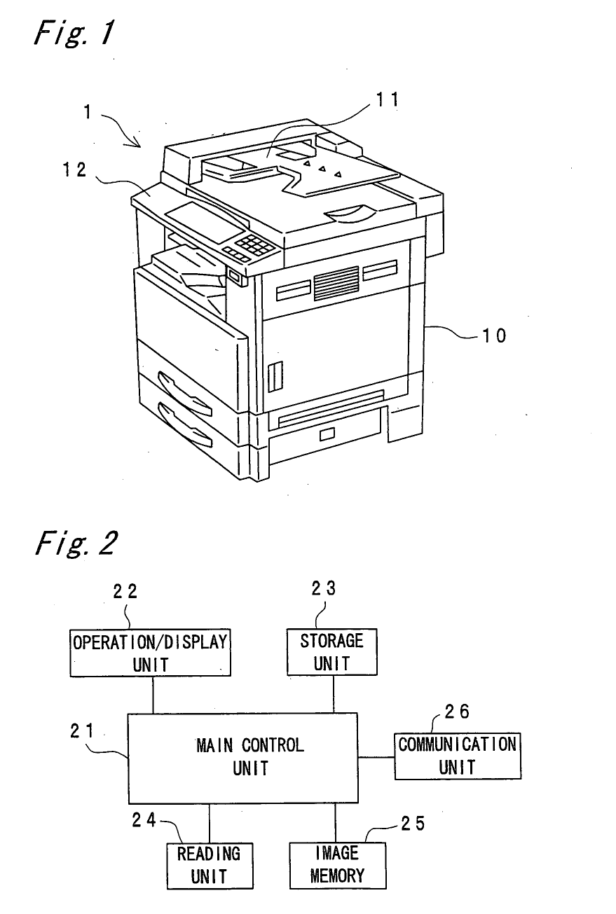

FIG. 2 shows a block configuration of a control system of the scanner device 1. The scanner device 1 has a main control unit 21 for controlling the whole device, an operation/display unit 22 connected to the main control unit 21, a storage unit 23 which serves as a storage section, a reading unit 24 which serves as a reading section, image memory 25, and a communication unit 26.

The operation/display unit 22 executes various display operations on a display section of the operation panel 12 and carries out processes for inputting instructions, data, and the like through the operation panel 12 from operators.

The storage unit 23 stores settings, communication records, and the like of the scanner device 1.

The reading unit 24 optically reads documents that are fed by the ADF 11 and thereby obtains image data of the documents. The reading unit is capable of scanning and reading a document loaded manually on a glass pane not shown.

The image memory 25 compresses and stores therein the image data obtained by the reading unit 24.

The communication unit 26 interfaces between the scanner device 1 and networks.

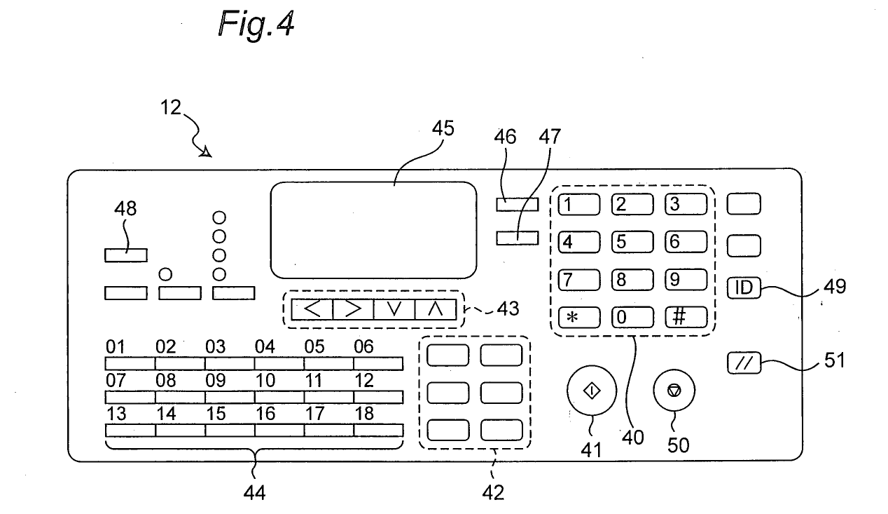

FIG. 4 specifically shows a configuration of the operation panel 12. The operation panel 12 includes a display section 45 for various displays in generally center upper part thereof. The panel also includes a sender registration key 48, eighteen one-touch sending keys 44 numbered from 01 to 18, four cursor keys 43 (a left key, a right key, a down key, and an up key), six calling sender keys 42, a finalizing key 46, a clear key 47, character input keys 40, a start key 41, a stop key 50, a reset key 51, and an ID key 49. Though the character input keys 40 are shown in form of ten key, alphabetic characters and/or Chinese characters can be inputted with use of the character input keys 40 in a manner similar to that for input by mail function of conventional portable telephones.

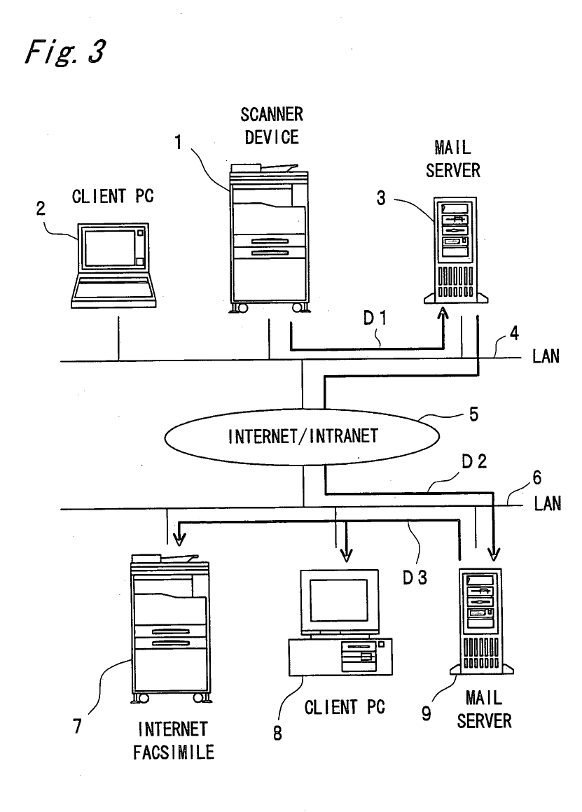

FIG. 3 shows a network environment provided with the scanner device 1. In this example, a LAN (local area network) 4 and a LAN 6 are connected to each other through the Internet or an intranet 5. To the LAN 4 are connected the scanner device 1, a client PC (personal computer) 2, and a mail server 3 for handling mail between the LAN 4 and external thereof. To the LAN 6 are connected an internet facsimile 7, a client PC 8, and a mail server 9 for handling mail between the LAN 6 and external thereof.

When the scanner device 1 in the LAN 4 attaches image data to email and sends the email to a recipient address that specifies the client PC 8 in another LAN 6, for example, the image data is sent from the scanner device 1 temporarily to the mail server 3 in the same LAN 4 (a path D1), is then sent from the mail server 3 in the LAN 4 through the Internet 5 to the mail server 9 in the LAN 6 (a path D2), and is then sent from the mail server 9 to the client PC 8 in the same LAN 6 (a path D3).

As is the case with conventional scanner devices, the scanner device 1 has an address for specification of the device in the networks 4, 5, and 6, that is, a sending station address. When image data is attached to email and the email is sent through the networks 4, 5, and 6 to a recipient address, the sending station address is added to the email. The scanner device 1 also sets up a sender address representing a sender, in place of the sending station address. The sender address is added to email.

Hereinbelow, operations of the scanner device 1 will be described as separated into a preparation stage (1) in which various information such as sender addresses is stored (registered) in the storage unit 23 of the device and a transmission stage (2) in which an operator actually carries out operations of image data transmission.

(1) Preparation Stage

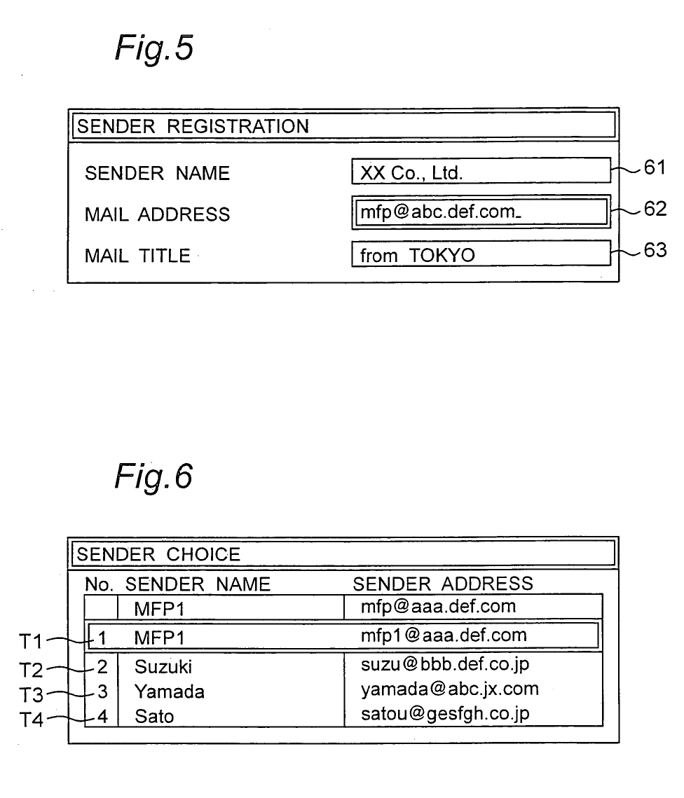

In order to store (register) a sender address in the storage unit 23 of the device, the operator presses down the sender registration key 48 on the operation panel 12 shown in FIG. 4. Then a sender registration screen as shown in FIG. 5 is displayed on the display section 45. In the sender registration screen are displayed a “SENDER NAME” field 61 into which a sender name, e.g., “XX Co., Ltd.” is to be inputted, a “MAIL ADDRESS” field 62 into which a sender address, e.g., “mfp@abc.def.com” is to be inputted, and a “MAIL TITLE” field 63 into which a title of mail, e.g., “from TOKYO” is to be inputted. The operator may press the up key or the down key 43 on the operation panel 12, shown in FIG. 4, to choose a field for desired input and may press the character input keys 40 to input a “sender name,” a “sender address,” and a “mail title,” separately. A set of these three pieces of information associated with one another will be referred to as “sender registration information.”

When the operator presses the finalizing key 46 after inputting the sender registration information the inputted sender registration information, i.e., the “sender name,” the “sender address,” and the “mail title” are registered in the storage unit 23 while remaining associated with one another. In this example, six sets of sender registration information can be registered.

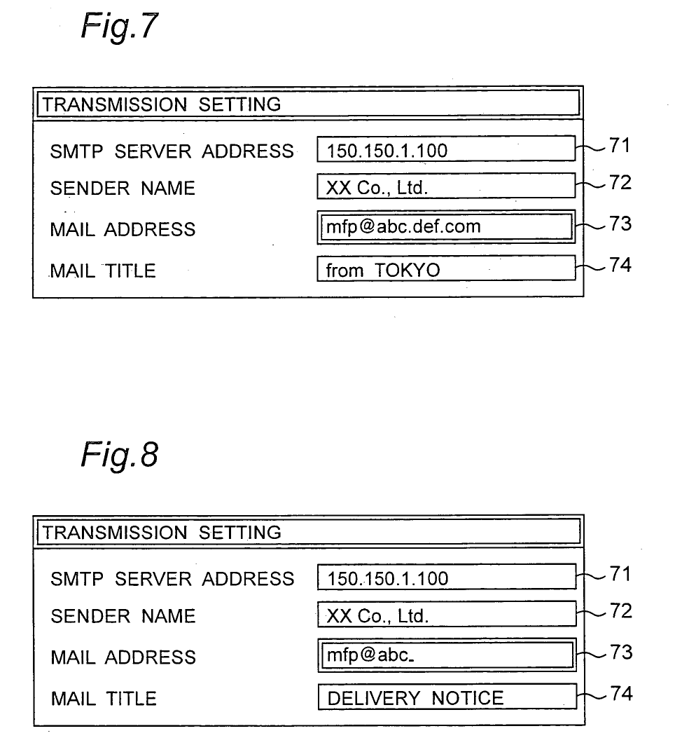

With a press on any of the calling sender keys 42 by the operator in the transmission stage, the registered sender registration information can be called up as shown in FIG. 6. In this example of FIG. 6, for example, a first set of sender registration information T1 includes a sender name “MFP1” and a sender address “mfp1@aaadef.com,” and a second set of sender registration information T2 includes a sender name “Suzuki” and a sender address “Suzu@bbb.def.co.jp.” In this example, the operator has pressed down a calling sender key 42 associated with the first set of sender registration information T1 and therefore the sender name “MFP1” has initially been chosen (as surrounded and indicated by a frame of double line for emphasizing). The operator may press the up key or the down key 43 on the operation panel 12 to choose any set of sender registration information T1,T2, . . . on a sender choice screen shown in FIG. 6. In an alternative configuration, a press on any calling sender key 42 by an operator may immediately invoke a screen in which settings on transmission have been finalized as shown in FIG. 7 (that will be described later), in accordance with the calling sender key 42, and a subsequent press by the operator on the up key or the down key 43 on the operation panel 12 may invoke such a sender choice screen as shown in FIG. 6.

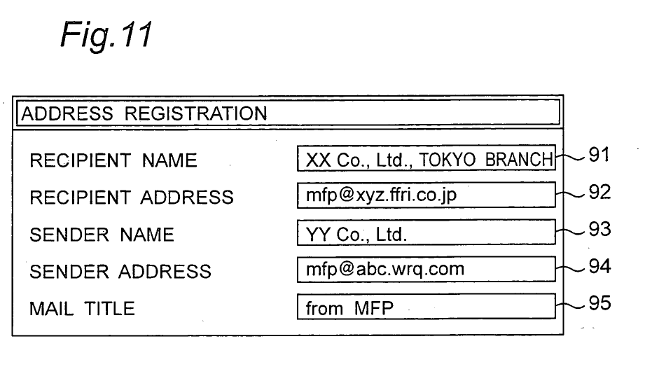

In the scanner device 1, “recipient name” and “recipient address” can be registered in addition to the “sender registration information” described above. That is, such an address registration screen as shown in FIG. 11 is displayed on the display section 45, when an operator presses the sender registration key 48 on the operation panel 12 and subsequently presses a one-touch sending key 44. On the address registration screen are displayed a “RECIPIENT NAME” field 91 into which a recipient name, e.g., “XX Co., Ltd., Tokyo branch” is to be inputted, a “RECIPIENT ADDRESS” field 92 into which a recipient address, e.g., “mfp@xyz.ffri.co.jp” is to be inputted, a “SENDER NAME” field 93 into which a sender name, e.g., “YY Co., Ltd.” is to be inputted, a “SENDER ADDRESS” field 94 into which a sender address, e.g., “mfp@abc.wrq.com” is to be inputted, and a “MAIL TITLE” field 95 into which a title of mail, e.g., “from MFP” is to be inputted. The operator may press the up key or the down key 43 on the operation panel 12 to choose a field for desired input and may press the character input keys 40 to input a “recipient name,” a “recipient address,” a “sender name,” a “sender address,” and a “mail title,” separately. A set of these five pieces of information associated with one another will be referred to as “one-touch registration information.” The operator inputs the associated five pieces of information while seeing all the pieces at once, and is therefore capable of checking contents of the information easily. This improves convenience for users.

When the operator presses the finalizing key 46 after inputting the one-touch registration information, the inputted one-touch registration information, i.e., the “recipient name,” the “recipient address,” the “sender name,” the “sender address,” and the “mail title” are registered in the storage unit 23 while remaining associated with one another. In this example, eighteen sets of one-touch registration information can be registered.

Even if an operator presses the finalizing key 46 for the one-touch registration on condition that any “recipient address” has not been inputted for each of the one-touch sending keys 44, in this example, an error display is effected and the one-touch registration cannot be executed.

(2) Transmission Stage

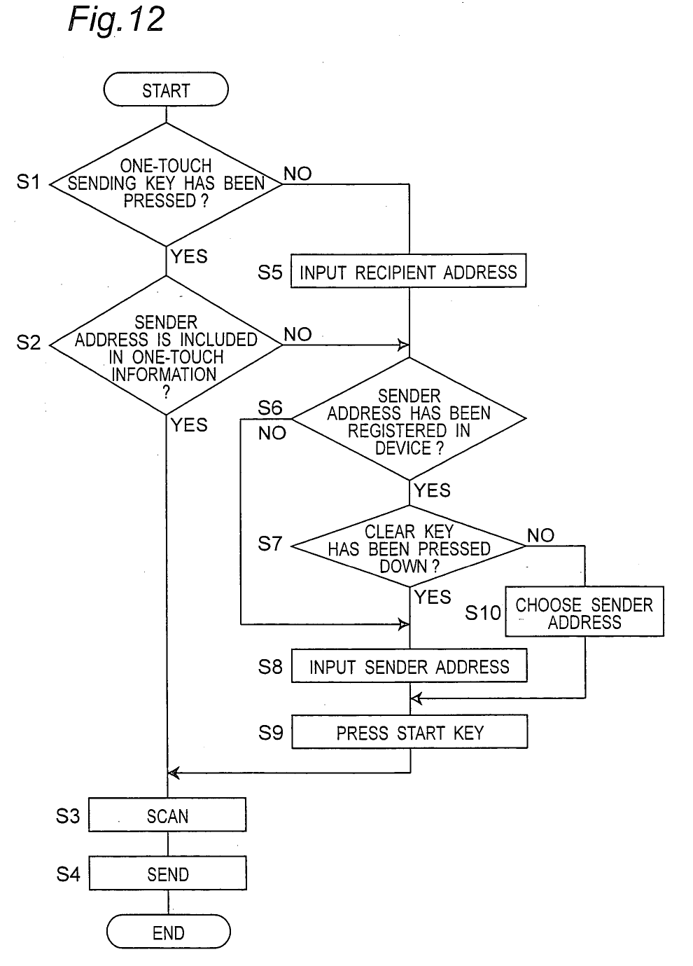

In the transmission stage in which an operator actually carries out operations of image data transmission, the scanner device 1 operates in accordance with such a flow as shown in FIG. 12 under control of the main control unit 21.

i) When a document is set in the ADF 11, whether any of the one-touch sending keys 44 have been pressed down or not is initially judged (S1).

If any of the one-touch sending keys 44 has been pressed down (if YES for S1), whether any “sender address” is included or not in “one-touch registration information” relating to the one-touch sending key is judged (S2).

If any “sender address” is not included in the “one-touch registration information” relating to the one-touch sending key (If NO for S2), the flow goes to a step S6 that will be described later.

If any “sender address” is included in the “one-touch registration information” relating to the one-touch sending key (If YES for S2), contents of the “one-touch registration information” are displayed on the display section 45 and the reading unit 24 immediately scans the document to obtain image data (S3). By viewing the contents of the “one-touch registration information” displayed on a screen on the display section 45, a sender is capable of checking easily whether the recipient address, the sender address, and the like are the same as the sender desires.

Subsequently, the main control unit 21 operates as first setting section and thus sets the “recipient address” included in the “one-touch registration information” as a recipient address to which the image data is to be sent. In tandem with this, the main control unit 21 operates as second setting section and thus substitutes the “sender address” included in the “one-touch registration information” for the sending station address specifying the device 1 so as to set the “sender address” as a sender address representing the sender. Then the main control unit 21 operates as transmission control section, thus adds the sender address set as above to the image data, and sends the image data to the recipient address set as above (S4). As a result, the image data is sent by the communication unit 26 through the networks 4, 5, and 6 to the recipient address set as above.

With use of the one-touch registration information as describe above, recipient address, sender address, and the like can promptly be programmed and the convenience for users (including senders) can be improved.

ii) If any one-touch sending key 44 is not pressed down in the step S1 (if NO for S1), the operator inputs through the operation panel 12 a recipient address as an address to which image data is to be sent (S5). The operator presses the character input keys 40 to input the recipient address manually. In case of false input, a press on the clear key 47 by the operator allows the input to be tried again.

When the operator presses the finalizing key 46 after inputting the recipient address, the main control unit 21 operates as first setting section and thus sets the “recipient address” as a recipient address to which the image data is to be sent. The flow then goes to the next step S6.

iii) In the step S6 is judged whether any “sender address” is included or not in the “sender registration information” stored in the storage unit 23 of the device 1 (S6).

If any “sender address” is included in the “sender registration information” (YES for S6) and the clear key 47 is not pressed down (NO for S7), such a sender choice screen as shown in FIG. 6 is displayed on the display section 45 on the operation panel 12 in order that the operator may be prompted to choose a set of the sender registration information (S10).

If any “sender address” is not included in the “sender registration information” (NO for S6) or the clear key 47 is pressed down (YES for S7) though “sender address” is included in the “sender registration information” (YES for S6), such a transmission setting screen as shown in FIG. 8 is displayed on the display section 45 on the operation panel 12 in order that the operator may be prompted to manually input a sender address (S8). In the transmission setting screen are displayed an “SMTP SERVER ADDRESS” field 71 which represents such a mail server address as “150.150.1.100,” a “SENDER NAME” field 72 into which a sender name, e.g., “XX Co., Ltd.” is to be inputted, a “MAIL ADDRESS” field 73 into which a sender address is to be inputted, and a “MAIL TITLE” field 74 into which a title of mail, e.g., “DELIVERY NOTICE” is to be inputted. In an example of FIG. 8, an input operation in the “MAIL ADDRESS” field 73 is being conducted as shown by an example of “mfp@abc”.

When any set of the “sender registration information” is chosen in the step 10 and the finalizing key 46 is pressed down or when the “sender address” is manually inputted in the step. S8 and the finalizing key 46 is pressed down, the main control unit 21 operates as the second setting section and thus substitutes the finalized “sender address” for the sending station address specifying the device 1 so as to set the “sender address” as a sender address representing the sender. FIG. 7 illustrates the display screen in which settings on transmission have thus been finalized.

iv) When the operator subsequently presses down the start key 41 (S9), the reading unit 24 scans the document to obtain image data (S3). The main control unit 21 then operates as a transmission control section, thus adds the sender address set as above to the image data, and sends the image data to the recipient address set as above (S4). As a result, the image data is sent by the communication unit 26 through the networks 4, 5, and 6 to the recipient address set as above.

The sender may specify a mail address to which the sender desires replies to be sent (a mail address the sender can easily use), as the “sender address” included in the one-touch registration information or as the “sender address” that is inputted or chosen in the steps S8, S10. With this specification, a recipient who has received email (image data) by a terminal of the recipient connected to the networks 4, 5, and 6 is capable of identifying the sender of the email (the image data) on basis of the added sender address.

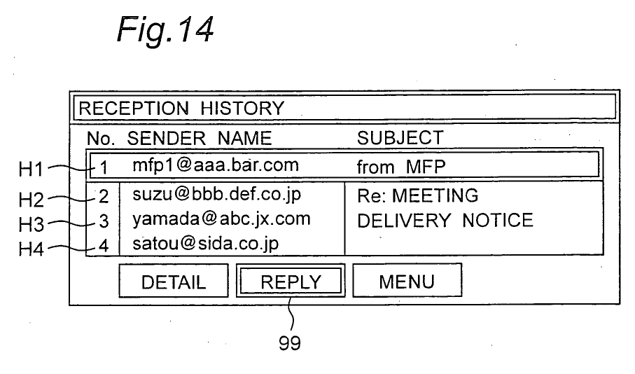

When the recipient starts a mail software (an application program) on the terminal of the recipient and invokes a reply function, the sender address is used as an address of reply mail responding to the email. For example, FIG. 14 shows a screen on which a recipient chooses an address of reply mail from reception history H1,H2, . . . of the recipient after starting a mail software on a terminal of the recipient. In this example of FIG. 14, for example, a first part of the reception history H1 is associated with a reception from the scanner device 1 and includes a sender address “mfp1@aaa.bar.com” and a subject “from MFP”. On the terminal on the recipient side is thus displayed the sender address, as an address representing a sender, in place of the sending station address specifying the scanner device 1. When the recipient chooses the first part of the reception history H1 and presses a “REPLY” key 99, the mail software automatically sets the address “mfp1@aaa.bar.com” as an address of reply mail. The sender address “mfp1@aaa.bar.com” is the address to which a person (the sender) having carried out the operations of image data transmission has desired replies to be sent. When the reply mail is sent to the sender address “mfp1@aaa.bar.com”, the sender is capable of opening and reading the reply mail easily, for example, with use of a client PC of the sender.

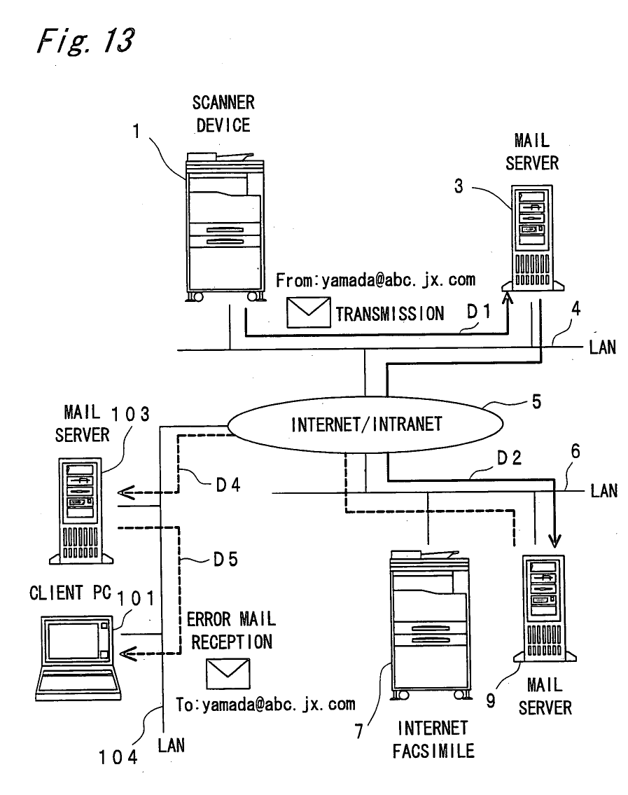

On condition that email (image data) having a sender address “yamada@abc.jx.com” added thereto is sent from the scanner device 1, e.g., as shown in FIG. 13 and that there is some failure in transmission paths D1 and D2 from the scanner device 1 to the server 9 on the recipient side, the sender address “yamada@abc.jx.com” is used as an address of error mail from the server 9 on the recipient side. The sender address “yamada@abc.jx.com” is an address to which a person (Mr. Yamada as a sender) having carried out the operations of image data transmission has desired replies to be sent, and is an address that specifies a client PC 101 of the person. When the error mail is delivered to the sender address “yamada@abc.jx.com” through paths D4 and D5 between which a mail server 103 intervenes, Mr. Yamada as the sender thus can easily find the delivery of the error mail. Besides, he can easily open and read the error mail with use of his client PC 101 and can swiftly take countermeasures against the error. In this example, a domain 104 to which Mr. Yamada's client PC 101, the mail server 103, and the like belong is different from domains 4 and 6 to which the scanner device 1 as the sending station, the client PC of the recipient, and the like belong.

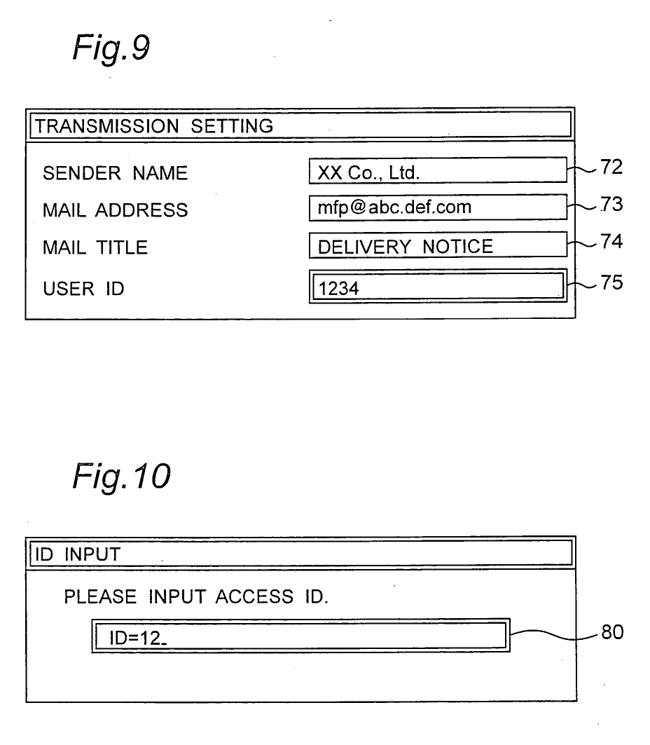

As shown in FIG. 10, such a message as “PLEASE INPUT ACCESS ID.” may be displayed on the display section 45, as a condition for start of operations of the scanner device 1. The message prompts an operator to input an ID that represents a user, in a field 80. The inputted ID in the field 80 may be associated with a sender address and stored in the storage unit 23 in advance before the operations of image data transmission. When an operator (a sender) has inputted an ID as the condition for start of operations of the scanner device 1, the above arrangement allows such a transmission setting screen that includes “USER ID” field 75 as shown in FIG. 9 to be invoked immediately in accordance with the inputted ID. Accordingly, the operator does not have to input the sender address letter by letter on the operations of image data transmission. This further improves convenience for users.

Candidates of recipient addresses associated with each sender address may be stored in the storage unit 23 in advance before the operations of image data transmission. This arrangement allows listed display of candidates of recipient addresses associated with each sender address. Thus an operator (a sender) does not have to input a recipient address letter by letter but only has to choose the recipient address from the candidates on the operations of image data transmission. This further improves convenience for users.

The operations in which various information such as a sender address is stored in the storage unit 23 of the device and is inputted or chosen may be conducted not only through the operation panel 12 of the scanner device 1 but also through the networks 4, S, and 6 from remote terminals.

The order of processes prior to the actual sending (S4) may be altered appropriately. That is, the order of processes may arbitrarily be altered among the process (S3) by the reading unit 24 of scanning a document and obtaining image data, the process (S5) of setting a recipient address to which image data is to be sent, and the process (S8, S10) of setting a sender address representing a sender in place of the sending station address specifying the device 1.

In this embodiment, the sending station address specifying the scanner device 1 is replaced by a sender address representing a sender. The sending station address specifying the scanner device 1, however, may be included in contents of a text of mail and may be informed to a recipient additionally.

Not only image data obtained from scanning of a document but image data stored in image memory may be sent.

In accordance with the network scanner device and the image data transmitting method thereby of the invention, as is evident from the above description, a person having performed the operations of image data transmission is capable of easily using reply mail and error mail responding to the transmission.

The invention being thus described, it will be obvious that the same may be varied in many ways. Such variations are not be regarded as a departure from the spirit and scope of the invention, and all such modifications as would be obvious to one skilled in the art are intended to be included within the scope of the following claims.

What is claimed is:

1. A network scanner device for transmitting image data through networks, comprising:
a reading section for scanning a document to obtain image data,
a first setting section for setting up a recipient address to which the image data is to be transmitted,
a second setting section for setting up a sender address representing a sender in place of a sending station address specifying the device, and
a transmission control section for carrying out control for adding to the image data the sender address set by the second setting section and transmitting the image data to the recipient address set by the first setting section.

2. A network scanner device as claimed in claim 1, further comprising a one-touch setting section for setting up the recipient address and the sender address simultaneously.

3. A network scanner device as claimed in claim 2, wherein the one-touch setting section carries out setting of the recipient address and the sender address, in accordance with instructions by the sender.

4. A network scanner device as claimed in claim 2, further comprising a display section that is capable of displaying information including the recipient address and the sender address.

5. A network scanner device as claimed in claim 1, further comprising a storage section in which candidates of recipient addresses associated with each sender address are stored,
wherein, on setting of the sender address, the recipient address is chosen from candidates of recipient addresses associated with the sender address.

6. A network scanner device as claimed in claim 1, further comprising a storage section in which sender addresses associated with IDs representing users are stored,
wherein the sender address is automatically set up in accordance with an inputted ID.

7. A network scanner device as claimed in claim 6, further comprising an ID input prompting section for making a display that prompts input of an ID representing a user, as a condition for start of operations of the device.

8. A network scanner device as claimed in claim 1, further comprising an operation panel by which information including the recipient address and the sender address is inputted or chosen.

9. A network scanner device as claimed in claim 1, wherein information including the recipient address and the sender address can be inputted through networks.

10. A network scanner device as claimed in claim 1, wherein the sending station address specifying the device is included in contents of a text of mail to which the image data is added.

11. A network scanner device for transmitting image data through networks, comprising:
image memory in which image data is stored,
a first setting section for setting up a recipient address to which the image data is to be transmitted,
a second setting section for setting up a sender address representing a sender in place of a sending station address specifying the device, and
a transmission control section for carrying out control for adding to the image data the sender address set by the second setting section and transmitting the image data to the recipient address set by the first setting section.

12. An image data transmitting method of a network scanner device which attaches image data to electronic mail and transmits the image data through networks, comprising steps of:
scanning a document and obtaining the image data,
setting a recipient address to which the image data is to be transmitted,
setting a sender address representing a sender, in place of a sending station address specifying the device, and
adding the set sender address to the image data and transmitting the image data to the set recipient address through the networks.

13. An image data transmitting method as claimed in claim 12, wherein the step of scanning a document and obtaining image data, the step of setting the recipient address to which the image data is to be transmitted, and the step of setting the sender address representing the sender in place of the sending station address specifying the device are carried out in an altered sequence.
